(19) United States
(12) Patent Application Publication
(10) Pub. No.: US 2002/0166738 A1
(43) Pub. Date: Nov. 14, 2002

(54) Self-ventilating disc brake rotor with outboard vent ports

(76) Inventor: Stephen Patrick Gavin, Beteau Bay (AU)

Correspondence Address: Jacobson & Johnson, Suite 285, One West Water St., St. Paul, MN, 55106-2033, US

(21) Appl. No.: 09/888,942

(22) Filed: Jun. 25, 2001

(30) Foreign Application Priority Data
May 10, 2001 (AU) PR4864

(51) Int. Cl. F16D 55/02; F16D 65/12

(52) U.S. Cl. 188/218 XL; 188/264 AA; 188/71.6

(57) ABSTRACT

There is a brake disc rotor having a central hat (1) co-axial with surrounding rings (2) which form brake bands (3) for engagement with brake pads. The rings (3) are supported in a spaced apart parallel configuration with channels (12) therebetween whereby in use of the rotor cooling air is drawn in through vent means formed around the inner periphery of the rings (3) and then radially outwardly through the channels (12) as the rotor turns. The vent means include inlet vent ports (7) on the outboard side of the rotor.

### FIELD OF THE INVENTION

This invention relates to brake apparatus. More particularly although not exclusively it discloses an improved rotor for vehicle disc brakes.

### BACKGROUND OF THE INVENTION

Existing disc brake rotors typically comprise a central hub or hat co-axial with a surrounding ring and a brake band adapted for frictional contact with brake pads on each side. With self-ventilating disc brakes there are two spaced apart parallel rings and bands provided on each rotor which are cooled by a radial flow of air outwardly through channels formed between them. This flow largely results from centrifugal forces generated by rotation of the rotor. With prior art brake rotors the flow of cooling air typically enters through vents or ports surrounding the hat on only one side of the rotor. With many vehicles however the front wheel assembly and splash plate significantly restrict or reduce this inflow of air. The result is excessive temperatures during severe braking which can cause swelling, cracking and stress fatigue in the rotor disc.

### SUMMARY OF THE INVENTION

It is therefore an object of this invention to ameliorate the aforementioned disadvantage and accordingly a disc brake rotor is disclosed which includes a central hat co-axial with surrounding rings which form brake bands for engagement with brake pads, said rings being supported in a parallel spaced apart configuration with channels therebetween whereby in use of the rotor cooling air is drawn in through vent means formed around the inner periphery of said rings and then radially outwardly through said channels as the rotor turns wherein said vent means include inlet vents located on the outboard side of said rotor.

Preferably the sides of the hat taper outwardly and form a deep heat dam in the area adjoining the rings.

It is further preferred that the rings are supported in said spaced apart configuration by sets of pillars arranged in clusters.

### BRIEF DESCRIPTION OF THE DRAWINGS

The currently preferred embodiment of the invention will now be described with reference to the attached drawings in which:

FIG. 1 is a perspective view of a brake rotor from the outboard side,

FIG. 2 is a perspective view of the rotor from the opposite inboard side,

FIG. 3 is a cross-sectional view of the rotor along the lines A-A of FIG. 1 showing the preferred form of the vent ports,

FIG. 4 is an elevation view of the outboard side of the rotor, and

FIG. 5 is a detailed view showing the preferred cross-sectional shape and arrangement for the pillars.

### DETAILED DESCRIPTION OF THE PREFERRED EMBODIMENT

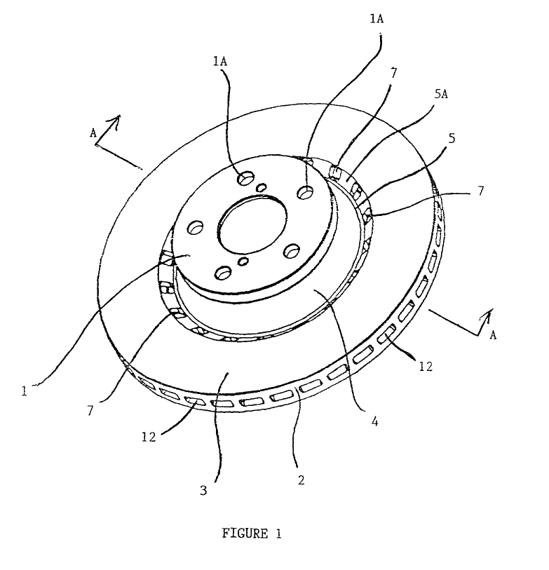

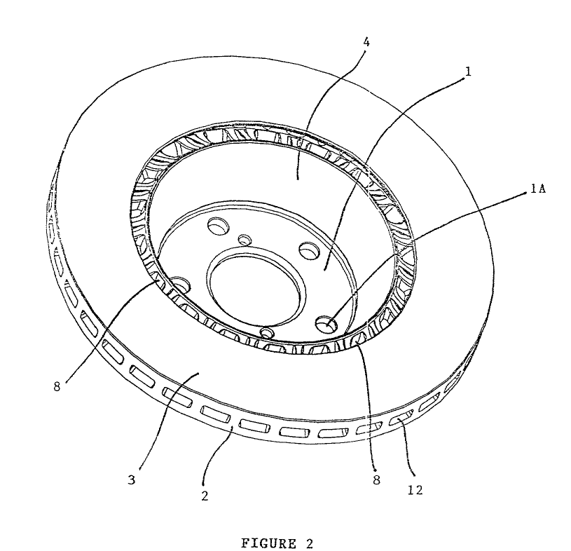

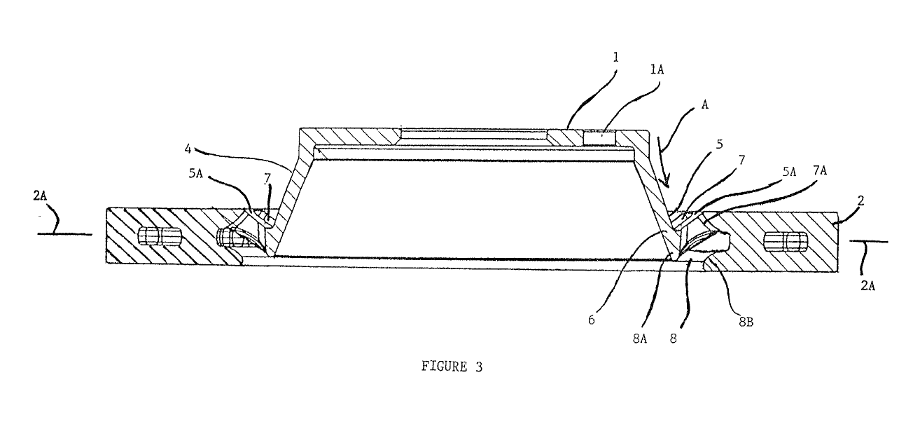

Referring first to FIGS. 1 to 3 there is a brake rotor comprising a central hub or hat 1 for mounting a vehicle wheel by means of bolts passing through apertures 1A. Surrounding the hat and co-axial with it are rings 2 which form brake bands 3 on the inboard and outboard sides for engagement with brake pads (not shown). The rings 2 are supported in a spaced apart parallel configuration by pillars with radial ventilation channels formed between them as described in more detail later. In accordance with this invention the sides 4 of the hat are inclined outwardly at about 4 degrees as best shown in FIG. 3. The outer periphery of the hat leads into a deep heat dam 5. This construction closely aligns the web 6 with the centre-line 2A of the rotor rings 2 to reduce vibration, better defines a heat distortion point for the rotor and also facilitates a smooth flow of air into the outboard vent ports 7. These ports 7 receive a flow of cooling air unobstructed by the front wheel assembly and splash plate. They are preferably rectangular in shape and are set into the outer face 5A of the heat dam in order to pick up the air flow along inclined sides of the hat (see arrow A in FIG. 3). The vent outboard wall 7A preferably has a large radius surface (e.g about 20 mm) to minimise flow friction by smoothly merging into the ventilation channels between the pillars. Also shown in FIGS. 2 and 3 are vent ports 8 leading into the ventilation channels from the inboard side of the rotor. These ports 8 are distributed around the inner periphery of the rings 2. The port walls are defined by a contoured inlet horn 8A formed by the inboard face of the tapered hat sides 4. The opposite port walls 8B are formed by the inner periphery of the rings 2. They are also contoured to lead smoothly into the ventilation channels. To assist the radial inflow of air into the ports 8 the wall 8B preferably extends out further from the rotor centre line 2A than the opposite horn 8A.

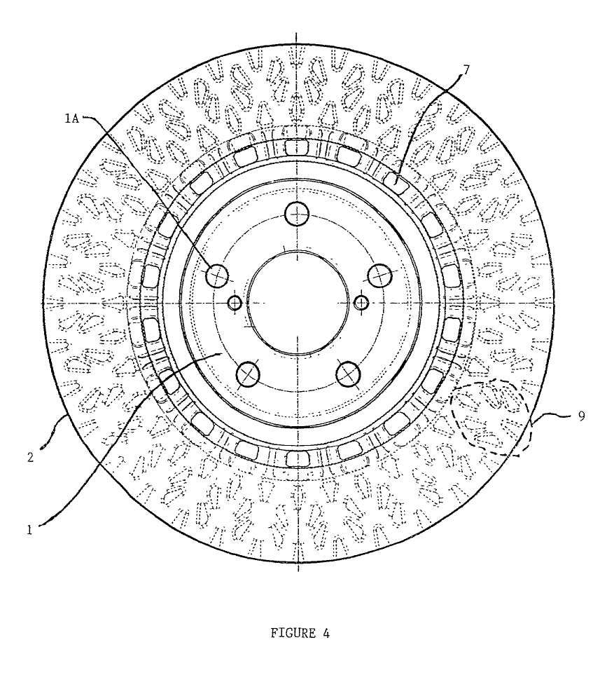

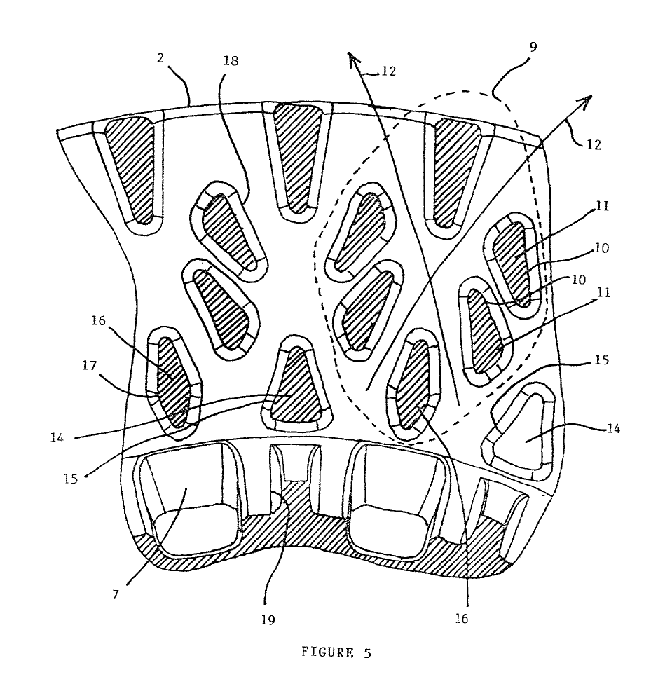

The preferred arrangement of the support pillars between the rings is shown in FIGS. 4 and 5. With this embodiment the pillars are disposed in repeating clusters of six units as indicated by broken line 9. Each cluster by means of the overlapping edges 10 and the elongated triangular shape of the pillars 11 defines radial air flow channels 12 out between the rings in accordance with the direction of rotation. There are also inner pillars 14 which are preferably triangular or bell shaped in cross-section so that the curved edges 15 act as air scoops to draw air in through the vent ports 8 and 9. Alternating with these pillars 14 are elongated diamond shaped pillars 16 which are asymmetrical in the radial direction so that the widest point 17 is offset toward the centre of the rotor. This shape has been found to better deflect and draw the air from the vent ports into the channels.

As the layout of each pillar cluster is preferably symmetrical with respect to the two opposite rotational directions dedicated left and right rotors are unnecessary with this embodiment. The air flow passes equally through either of the channels 12 in accordance with the direction of rotation.

The bases of the pillars are preferably radiused at 18 to prevent stress concentrations. Strengthening ribs 19 have also be formed on the web between the outboard ports to prevent cracking.

It will thus be appreciated that this invention at least in the form of the embodiment disclosed comprises a novel and improved form of disc brake rotor. Clearly however the example described is only the currently preferred form of this invention and a wide variety of modifications may be made which would be apparent to a person skilled in the art. For example the design of the hat and brake bands as well as the shape and configuration of the vent ports and pillars may be changed according to application. Also while the rotor is preferably cast using G220 grey iron the invention extends to the use of any other suitable material.

The claims defining the invention are as follows:

1. A disc brake rotor having a central hat co-axial with surrounding rings which form brake bands for engagement with brake pads, said rings being supported in a parallel spaced apart configuration with channels therebetween whereby in use of the rotor cooling air is drawn in through vent means formed around the inner periphery of said rings and then radially outwardly through said channels as the rotor turns wherein said vent means include inlet vents on the outboard side of said rotor

2. The disc brake rotor as claimed in claim 1 wherein there are hat sides which are inclined outwardly towards the base of said hat and the outer periphery of the hat leads into a heat dam.

3. The disc brake rotor as claimed in claim 2 wherein ports for said inlet vents on the outboard side are located in an outer face of said heat dam.

4. The disc brake rotor as claimed in claim 3 wherein said vent means further include inlet vents on the inboard side of said rotor.

5. The disc brake rotor as claimed in claim 4 wherein ports for said inlet vents on the inboard side of the rotor are located between an inner periphery of one of said rings and a contoured inlet horn formed by an inboard face of said hat sides.

6. The disc brake rotor as claimed in claim 5 wherein the inlet vents on the inboard and outboard sides of the rotor lead into said channels between said rings, said channels being defined by pillars.

7. The disc brake rotor as claimed in claim 6 wherein said pillars are arranged in clusters with each cluster being symmetrical with respect to rotational directions of the rotor.

8. The disc brake rotor as claimed in claim 7 wherein each cluster defines a respective pair of the channels and cooling air passes equally through one or the other thereof in accordance with the direction of rotor rotation.

9. The disc brake rotor as claimed in claim 9 wherein each cluster includes pillars which in cross-section are of elongated triangular shape and have overlapping edges to define said pair of the channels.

10. The disc brake rotor as claimed in claim 10 wherein each cluster further includes inner pillars which have an elongated diamond shape in cross-section and alternate with pillars which are triangular or bell shaped in cross-section, said inner pillars being adapted to deflect and draw cooling air from said inlet vents into said channels.
